(19) United States
(12) Patent Application Publication
(10) Pub. No.: US 2012/0293728 A1
(43) Pub. Date: Nov. 22, 2012

(54) LIGHTING DEVICE, DISPLAY DEVICE AND TELEVISION RECEIVER

(75) Inventor: Ryuhichi Yokohama, Osaka-shi (JP)

(73) Assignee: SHARP KABUSHIKI KAISHA, Osaka-shi, Osaka (JP)

(21) Appl. No.: 13/574,697

(22) PCT Filed: Jan. 13, 2011
(86) PCT No.: PCT/JP2011/050426

§ 371 Date: Jul. 23, 2012

(30) Foreign Application Priority Data
Jan. 26, 2010 (JP) 2010-014192

(51) Int. Cl. F21V 8/00; G02F 1/13357; H04N 5/66; F21V 13/02

(52) U.S. Cl. 348/739; 362/613; 362/609; 349/65; 348/E05.133

(57) ABSTRACT

The distance between a light guide plate and a light source is maintained within a certain range, and thus an optical design for a lighting device is maintained. A backlight unit 24 includes a board holding member 19 fixed to a backlight chassis 22 and an LED board 30 is attached thereto such that the board holding member 19 holds the board 30. A protrusion 19a provided on the holding member 19 is fitted in a recess 30a provided in the LED board 30 such that the board 30 is held by the holding member 19. The holding member 19 includes a restriction portion 19b provided between the light guide plate 20 and the board 30 and having a thickness greater than a thickness W2 of the LED light source 28 such that the distance between the guide plate 20 and the board 30 is maintained because of a thickness W1 of the restriction portion 19b.

### TECHNICAL FIELD

The present invention relates to a lighting device, a display device and a television receiver.

### BACKGROUND ART

In recent years, a type of a display element of an image display device including a television receiver has been shifted from a conventional CRT display device to a thin display device using a thin display element such as a liquid crystal panel and a plasma display and a thin image display device is made possible. A liquid crystal panel included in a liquid crystal display device does not emit light, and thus a backlight unit is required as a separate lighting device.

A backlight unit including a light source board, light sources, a light guide plate, a housing member and a board holding member is known. The light sources are arranged on a front surface of the light source board. The light guide plate guides light from the light sources. The housing member houses the light source board and the light guide plate. The board holding member holds the light source board, and accordingly, the light source board is placed in the housing member. In the backlight unit, heat generated in the vicinity of the light source board is dissipated while being transmitted from the housing member to outside the backlight unit through the board holding member, and thus high heat dissipation efficiency is achieved in the backlight unit. Such a backlight unit is disclosed in Patent Document 1 and Patent Document 2, for example.

Patent Document 1: Japanese Unexamined Patent Publication No. 2007-311327
Patent Document 2: Japanese Unexamined Patent Publication No. 2008-186780

### Problem to be Solved by the Invention

The light guide plate may expand toward the light sources due to heat generated near the light source board, for example. In the backlight unit disclosed in Patent Document 1 or Patent Document 2, the distance between the light guide plate and the light source board is not maintained. If the light guide plate expands toward the light sources due to heat, the distance between the light guide plate and the light sources varies, and therefore, the optical design for the backlight unit cannot be maintained.

### DISCLOSURE OF THE PRESENT INVENTION

The present invention was accomplished in view of the above circumstances. It is an object of the present invention to provide technology of maintaining the distance between a light guide plate and a light source within a certain range in a lighting device that includes a board holding member holding a light source board on which the light source is arranged, and of maintaining an optical design for the lighting device.

### Means for Solving the Problem

A lighting device according to the present invention includes a light source board, at least one light source, a light guide plate, a housing member, a board holding member, a protrusion and a recess. The light source is provided on a surface of the light source board. The light guide plate includes a light entrance surface on a side and configured to guide light from the at least one light source. The housing member houses at least the light source board and the light guide plate. The board holding member is fixed to the housing member. The light source board is attached to the housing member such that the board holding member holds the light source board. The board holding member includes a restriction portion provided between the light guide plate and the light source board. The restriction portion has a thickness greater than that of the at least one light source such that a distance between the light guide plate and the light source board is maintained because of the thickness. The protrusion is provided on one of the light source board and the board holding member. The recess is provided in another one of the light source board and the board holding member. The another one of the light source board and the board holding member has a through hole. The protrusion is fitted in one of the recess and the through hole such that the light source board is held by the board holding member.

According to the lighting device disclosed in the technology, the board holding member not only holds the light source board but also maintains the distance between the light guide plate and the light source board. The board holding member holds the light source board, and thus the distance between the light guide plate and the light source is maintained within a certain range such that the light source board is held by the housing member. Therefore, the optical design for the lighting device is maintained.

In the lighting device, the protrusion may be formed in a rivet shape. Such a configuration allows the light source board to be properly fixed to the board holding member.

In the lighting device, the board holding member may have heat conductivity higher than that of the light source board. With such a configuration, heat that is generated in the vicinity of the light source board is dissipated effectively by the board holding member.

In the lighting device, the board holding member maybe apart of the housing member. With such a configuration, the housing member and the board holding member can be integrally formed.

In the lighting device, the at least one light source may include a plurality of light sources arranged linearly on the surface of the light source board and the protrusion may be fitted in one of the recess and the through hole between the adjacent light sources. With such a configuration, the lighting device can include a plurality of light sources and thus the brightness of the lighting device can be improved.

In the lighting device, the light source board may be electrically connected to an external terminal through a connector terminal or a flexible board. With such a configuration, the connecting portion between the light source board and external power source has flexibility, and thus a contact failure and a malfunction are less likely to occur.

The lighting device may further include a first reflection member. In the lighting device, the light entrance surface may be formed in an elongated shape. The first reflection member may extend along a long side of the light entrance surface between the at least one light source and the light guide plate. With such a configuration, light is dispersed out of the light guide plate from the light source and the dispersed light is directed to the light guide plate by the first reflection member. This improves the efficiency in directing light emitted from the light source to the light guide plate.

The lighting device may further include a second reflection member provided on a front surface of the light source board. With such a configuration, light is dispersed on the front surface of the light source board from the light source and the dispersed light is directed to the light guide plate by the second reflection member. This improves the efficiency in directing light emitted from the light source to the light guide plate.

The technology disclosed in the present invention may be described as a display device including a display panel configured to provide display using light from the lighting device. Furthermore, a display device configured to provide the display panel that is a liquid crystal panel using liquid crystal may be new and useful. Furthermore, a television receiver including the display device may be new and useful. The large-screen display device and the large-screen television receiver are made possible.

### Advantageous Effect of the Invention

According to the technology disclosed in the specification, in a lighting device including a board holding member that holds a light source board on which the light source is arranged, the distance between a light guide plate and a light source is maintained within a certain range and an optical design for the lighting device is maintained.

### BRIEF DESCRIPTION OF THE DRAWINGS

FIG. 1 is an exploded perspective view illustrating a general configuration of a television receiver TV according to a first embodiment of the present invention;

FIG. 2 is an exploded perspective view illustrating a liquid crystal display device 10;

FIG. 3 is a sectional view illustrating the liquid crystal display device 10;

FIG. 4 is a magnified sectional view illustrating a part of a backlight unit 24;

FIG. 5 is a front view illustrating a part of an LED unit 32 and a part of a board holding member 19;

FIG. 6 is a magnified sectional view illustrating a part of a backlight unit 54 according to a second embodiment;

FIG. 7 is a front view illustrating a part of an LED unit 62 and a part of a board holding member 49; and

FIG. 8 is a magnified sectional view illustrating a part of a backlight unit 84 according to a third embodiment.

### BEST MODE FOR CARRYING OUT THE INVENTION

### First Embodiment

A first embodiment of the present invention will be described. An X axis, a Y-axis and a Z-axis are described in a part of the drawings, and a direction of each axial direction corresponds to a direction described in each drawing. A Y-axis direction matches a vertical direction and an X-axis direction matches a horizontal direction. Unless otherwise noted, a top to bottom direction will be explained based on a vertical direction.

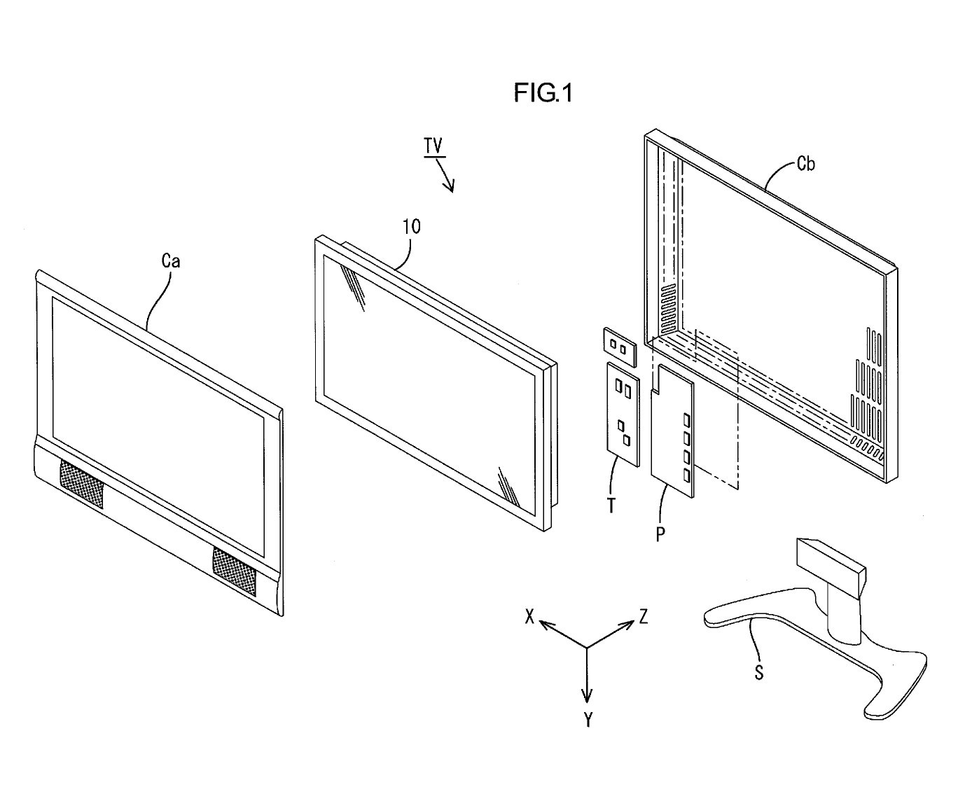

FIG. 1 illustrates an exploded perspective view of a television receiver TV according to a first embodiment. As illustrated in FIG. 1, the television receiver TV includes the liquid crystal display device 10, front and rear cabinets Ca, Cb that house the liquid crystal display device 10 therebetween, a power source P, a tuner T and a stand S.

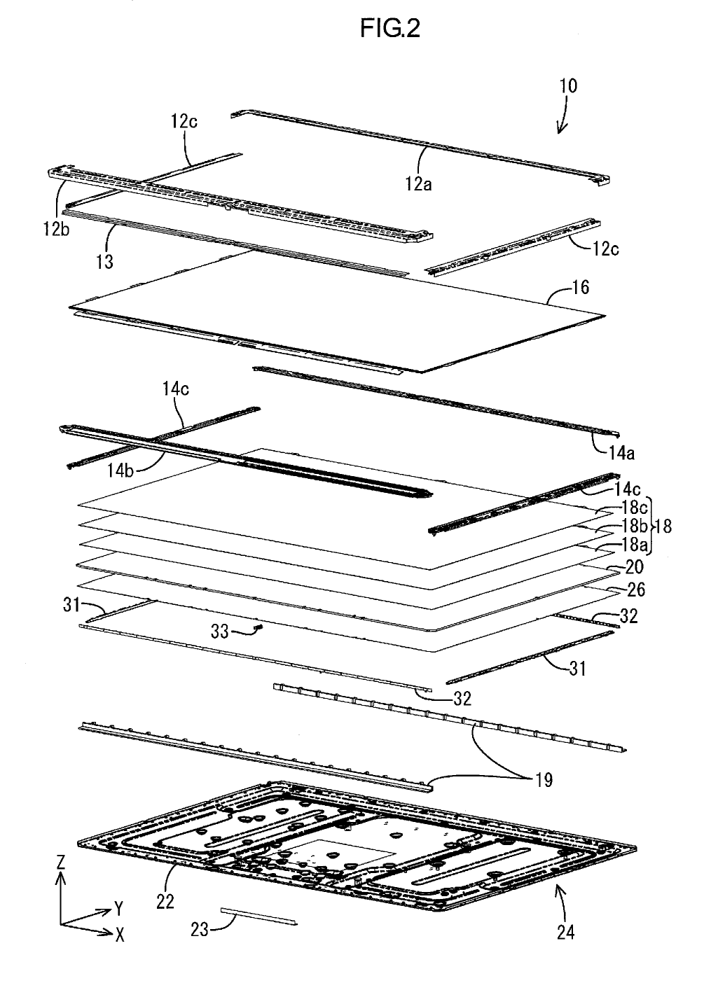

FIG. 2 illustrates an exploded perspective view of the liquid crystal display device 10. An upper side in FIG. 2 corresponds to a front-surface side and a lower side in FIG. 2 corresponds to a rear-surface side. An entire shape of the liquid crystal display device 10 is a landscape rectangular. As illustrated in FIG. 2, the liquid crystal display device 10 includes a liquid crystal panel 16 as a display panel, and a backlight unit 24 as an external light source. The liquid crystal panel 16 and the backlight unit 24 are integrally held by a top bezel 12a, a bottom bezel 12b, side bezels 12c (hereinafter a bezel set 12a to 12c) and the like.

As illustrated in FIG. 2, the liquid crystal panel 16 included in the liquid crystal display device 10 is formed in a rectangular plan view shape. A long-side direction of the liquid crystal panel 16 matches a horizontal direction (an X-axis direction) and a short-side direction thereof matches a vertical direction (a Y-axis direction). The liquid crystal panel 12 is configured such that a pair of transparent glass substrates (highly capable of light transmission) is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. A drive circuit board (not shown) supplies image data and various control signals that are necessary to display images to the source lines, the gate lines and the counter electrodes. Polarizing plates (not shown) are attached to outer surfaces of the substrates.

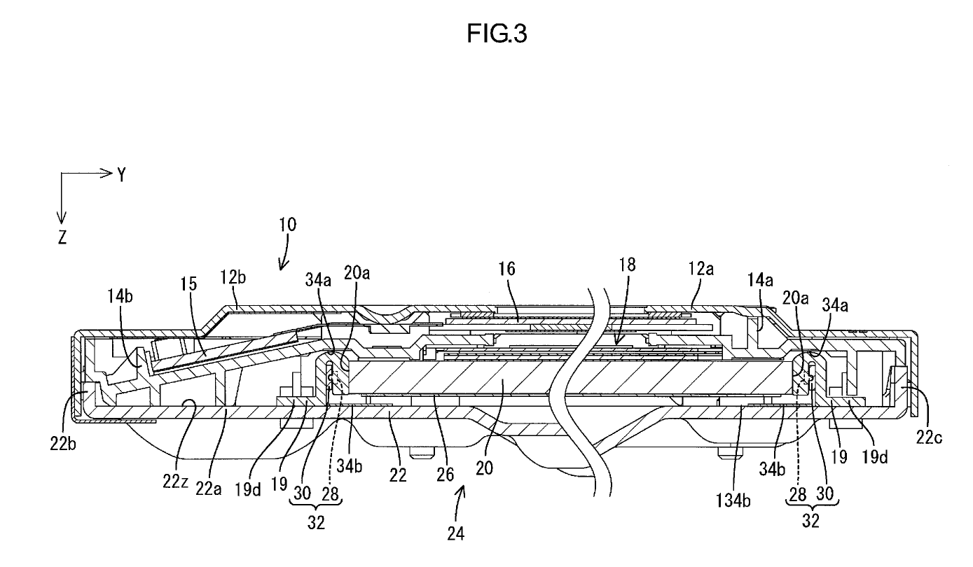

The backlight unit 24 will be described. As illustrated in FIG. 2, the backlight unit 24 includes a backlight chassis 22, optical members 18, a top frame 14a, a bottom frame 14b and side frames 14c (hereinafter a frame set 14a to 14c). The liquid crystal panel 16 is sandwiched between the bezel set 12a to 12c and the frame set 14a to 14c. A reference numeral 13 represents an insulating layer configured to insulate a driving circuit board 15 (see FIG. 3) for driving the liquid crystal panel 16. The substantially box-shaped backlight chassis 22 has an opening on the front-surface side (on the light exit side and the liquid crystal panel 16 side). Furthermore, the backlight chassis 22 houses a pair of cable holders 31 and 31, a pair of board holding members 19 and 19, a pair of LED (light emitting diode) units 32 and 32 and a light guide plate 20 in the backlight chassis 22. A power supply circuit board (not shown) configured to supply power to the LED units 32 and a protection cover 23 for protecting the power supply circuit board are mounted on the rear side of the backlight chassis 22.

The pair of cable holders 31 and 31 is arranged in the short-side direction of the backlight chassis 22 and holds cables electrically connected between the LED units 132 and the power supply circuit board. The pair of board holding members 19 and 19 is provided. The board holding members are arranged along respective long sides of the backlight chassis 22. The pair of LED units 32 and 32 extends along respective long sides of the backlight chassis 22. The LED units 32 and 32 are arranged inside the board holding members 19 and 19 and configured to emit light. Apart of each board holding member 19 extends inside the LED unit 32. The board holding members 19 hold the LED boards 30 (see FIG. 3). The light guide plate 20 is provided between the LED units 32 and 32 and is configured to guide light emitted from the LED units 32 toward the liquid crystal panel 16. The optical members 18 are provided on the front-surface side of the light guide plate 20. The light reflection sheet 26 is provided on the rear-surface side of the light guide plate 20. The LED units 32, the light guide plate 20 and the light reflection sheet 26 are supported each other by a rubber bushing 33. The light guide plate 20 and the optical members 18 are provided directly below the liquid crystal panel 16, and each LED unit 32 as a light source is provided at the side edge of the light guide plate 20. Namely, an edge-light type (side-light type) is used for the backlight unit 24 of the present embodiment.

The optical members 18 include laminated layers of a diffuser sheet 18a, a lens sheet 18b and a reflecting type polarizing sheet 18c in this order from the light guide plate 20 side. The diffuser sheet 18a, the lens sheet 18b and the reflecting type polarizing sheet 18c have a function for making planar light from light exiting from LED units 32. The liquid crystal panel 16 is provided on the front surface side of the reflecting type polarizing sheet 18c. The optical members 18 are provided between the light guide plate 20 and the liquid crystal panel 16.

The light guide plate 20 formed in a rectangular plate shape is made from a resin highly capable of light transmission (or with high clarity) such as acrylic. As illustrated in FIG. 2, the light guide plate 20 is provided between the LED units 32 facing each other such that the main plate of the light guide plate 20 faces to the diffuser sheet 18a. The light reflection sheet 26 is provided on a surface 20c of the light guide plate 20 that is opposite to a surface (light exit surface) 20b facing the diffuser sheet 18a. The light reflection sheet 26 reflects light leaking out of the light guide plate 20 and returns the light to the light guide plate 20. With such a configuration, light exiting from the LED units 32 enters the side plate surfaces (light entrance surfaces) 20a of the light guide plate 20. The light exits the main plate surface (light exit surface) 20b thereof facing the diffuser sheet 18a. Accordingly, the liquid crystal panel 16 is illuminated with the light from the rear side of the liquid crystal panel 16.

FIG. 3 illustrates a sectional view of the liquid crystal display device 10. The backlight chassis 22 is formed in a rectangular plan view shape and made of metal such as aluminum material. As illustrated in FIG. 3, the backlight chassis 22 includes the bottom plate 22a having a bottom surface 22z and the side plates 22b and 22c each of which rises shallowly from an outer edge of the corresponding side of the bottom plate 22a toward the front surface side. The long-side direction of the bottom plate 22a matches a horizontal direction (X-axis direction). The short-side direction of the bottom plate 22a matches a vertical direction (Y-axis direction).

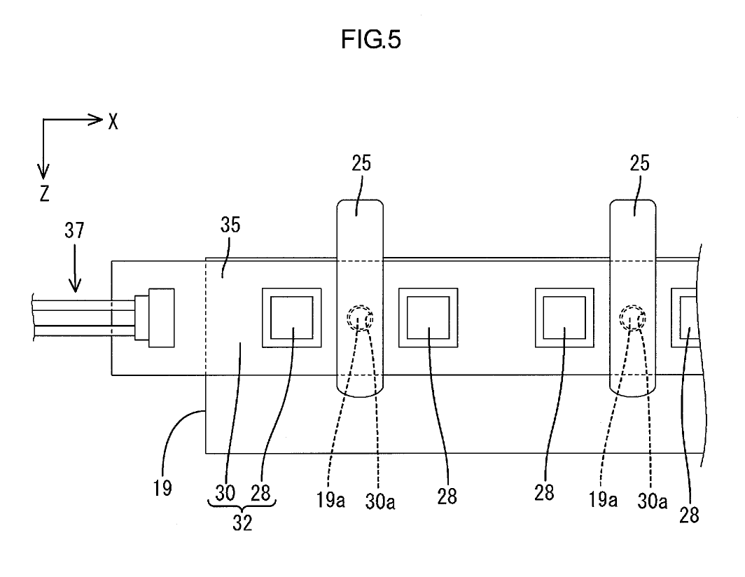

As illustrated in FIG. 3, the bottom plate portion 19d of the board holding member 19 is mounted on the bottom plate 22a of the backlight chassis 22. Each of the LED units 32 includes an LED board 30 and a plurality of LED light sources 28. The rectangular LED board 30 is made from resin. The LED light sources 28 are arranged linearly in a line on the LED board 30 and configured to emit white light (see FIG. 5). Each of the board holding members 19 holds the LED board 30 such that the light exit sides of LED light sources 28 face the board holding member 19, and accordingly, the pair of the LED units 32 and 32 is mounted on the backlight chassis 22. Each of the LED light sources 28 may include a blue light emitting diode coated with a fluorescent material having an emission peak in a yellow range to emit white light. The LED light source 28 may include a blue light emitting diode coated with a fluorescent material having an emission peak in a green range and a red range to emit white light. The LED light source 28 may include a blue light emitting diode coated with a fluorescent material having an emission peak in a green range and a red light emitting diode to emit white light. The LED light source 28 may include a blue light emitting diode, a green light emitting diode and a red light emitting diode to emit white light. The LED light source 28 may include an ultraviolet light emitting diode and a fluorescent material. Particularly, the LED light source 28 may include an ultraviolet light emitting diode coated with a fluorescent material having an emission peak in a blue range, a green range and a red range to emit white light.

The driving circuit board 15 is provided on the front-surface side of the bottom frame 14b. The driving circuit board 15 is electrically connected to the display panel 116 to supply image data and various control signals that are necessary to display images with the liquid crystal panel 16. Reflection sheets 34a are provided on a surface of the top frame 14a and a surface of the bottom frame 14b that are exposed to the LED units 32. Each of the reflection sheets 34a is arranged along the long side of the light entrance surface 20a of the light guide plate 20. Reflection sheets 34b are provided on a front surface of the backlight chassis 22 that faces the LED units 32. The reflection sheets 34b are arranged along respective long sides of the light entrance surface 20a of the light guide plate 20.

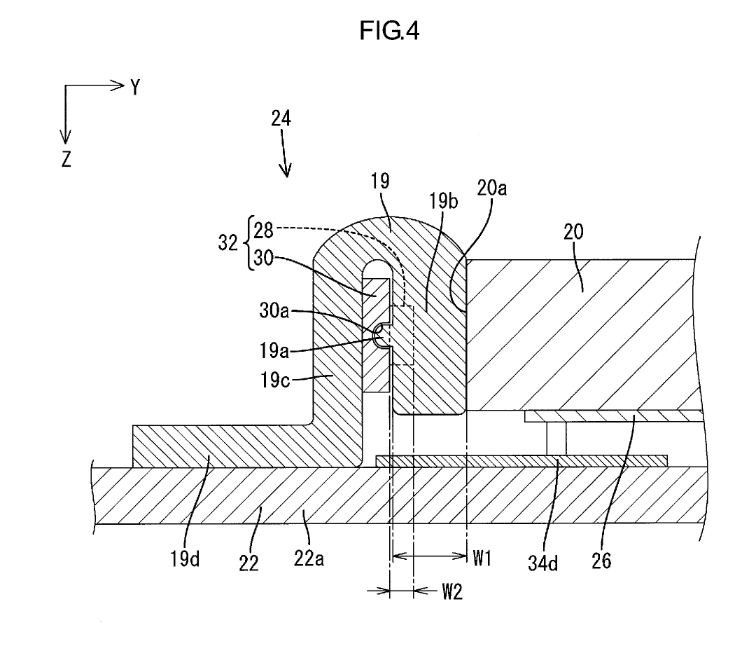

A magnified sectional view of a part of the backlight unit 24 is illustrated in FIG. 4. FIG. 4 illustrates a sectional configuration of the vicinity of one of the board holding members 19 in the backlight unit 24 taken along the YZ plane so as to pass through the board holding member 19. As illustrated in FIG. 4, the board holding member 19 includes the bottom plate portion 19d, a side plate portion 19c, a restriction portion 19b and a protrusion 19a. The bottom plate portion 19d is fastened with screws on the bottom plate 22a of the backlight chassis 22. The side plate portion 19c rises from the bottom plate portion 19d. The side plate portion 19c has an inner surface on which the LED board 30 is mounted. The restriction portion 19b extends from the side plate portion 19c to an inner surface of the LED board 30 with passing above the upper side of the LED board 30. The restriction portion 19b is provided between the LED light sources 28 and the light guide plate 20. The restriction portion 19b is in contact with the light entrance surface 20a of the light guide plate 20. A thickness W1 of the restriction portion 19b is greater than a thickness W2 of each LED light source 28. Even if the light guide plate 20 is extracted toward the LED light sources 28, the distance between the LED light sources 28 and the light guide plate 20 is not shorter than the thickness of the restriction portion 19b, and the distance between the LED light sources 28 and the light guide plate 20 is maintained within a certain range. With the thickness W1, the restriction portion 19b maintains the distance between the LED light sources 28 and the light guide plate 20.

The protrusion 19a of the board holding member 19 is provided on a front surface of the restriction portion 19b that faces the LED board 30. The protrusion 19a is formed in a hemispherical shape so as to project toward the LED board 30. A recess 30a is provided in a front surface of the LED board 30 that faces the protrusion 19a of the board holding member 19. The recess 30a has a size such that the protrusion 19a can be fitted therein. As illustrated in FIG. 4, the protrusion 19a of the board holding member 19 is fitted in the recess 30a. Accordingly, the board holding member 19 holds the LED board 30 and fixes the position thereof.

Heat generated in the vicinity of the LED light source 28 is dissipated while being transmitted from the backlight chassis 22 to outside the backlight unit 24 through the board holding member 19. The board holding member 19 is made of metal and the LED board 30 is made of resin. The thermal conductivity of board holding member 19 is higher than that of the LED board 30.

Next, how to mount the LED board 30 on the board holding member 19 will be explained. First, a connecting portion of the board holding member 19 connecting the side plate portion 19c and the restriction portion 19b is bent such that the lower part of the restriction portion 19b is open to the light guide plate 20 side. The board holding member 19 is formed from metal having flexibility such as aluminum and thus the connecting portion can be bent with a light load applied thereto. Next, the LED board is inserted between the side plate portion 19c and the restriction portion 19b in a state where the lower part of the restriction portion 19b is open to the light guide plate 20 side. Then, the protrusion 19a of the board holding member 19 is fitted in the recess 30a of the LED board 30, and the lower part of the restriction portion 19b is closed. Accordingly, the LED board 30 is mounted on the board holding member 19.

FIG. 5 illustrates a front view of a part of the board holding member 19 and a part of the LED unit 32. As illustrated in FIG. 5, a plurality of LED light sources 28 are arranged linearly on the front surface of the LED board 30. The restriction portions 19b are arranged at equal intervals and each of the restriction portions 19b is provided between the adjacent LED light sources 28. The protrusion 19a of the board holding member 19 is fitted in the recess 30a of the LED board 30 between the adjacent LED light sources 28. Namely, a plurality of restriction portions 19b extend from the sideplate portion 19c at equal intervals, and the protrusions 19a are provided on the front surfaces of the restriction portions 19b, respectively. Each of the restriction portions 19b is provided between the adjacent LED light sources 28, and thus the restriction portions 19b do not block light that is emitted from the LED light sources 28 and enters the light entrance surface 20a of the light guide plate 20.

A white resist 35 is applied to a part of the surfaces of the LED board 30 in which the LED light sources 28 and the recesses 30a are not provided. The white resist 35 is configured to reflect light from the LED light sources 28. Connector terminals 37 are connected with horizontal ends of the LED board 30. The LED board 30 is electrically connected to the power supply circuit board via the connector terminals 37.

The television receiver TV of the present embodiment has been described in detail. The board holding member 19 not only holds the LED board 30, but also maintains the distance between the light guide plate 20 and the LED board 30 in the backlight unit 24 of the television receiver TV according to the present embodiment. The board holding member 19 holds the LED board in the backlight chassis 22, and thus the distance between the light guide plate 20 and the LED light source 28 is maintained within a certain range. Therefore, the optical design for the backlight unit 24 is maintained.

In the present embodiment, the heat conductivity of the board holding member 19 is higher than that of the LED board 28. Accordingly, heat generated in the vicinity of the LED board 28 is effectively dissipated by the board holding member 19.

In the present embodiment, a plurality of LED light sources 28 are arranged linearly on the front surface of the LED board 30. The protrusion 19a of the board holding member 19 is fitted in the recess 30a of the LED board 30 between the adjacent LED light sources 28. Therefore, the backlight unit 24 can include a plurality of LED light sources 28 and thus the brightness of the backlight unit 24 can be improved.

In the present embodiment, the LED board 30 is electrically connected to external terminals through the connector terminals 37. Connecting portions between the LED board 30 and the external terminals have flexibility, and therefore, a contact failure and a malfunction are less likely to occur.

In the present embodiment, the light entrance surface 20a is formed in an elongated shape and reflection members 34a and 34b are arranged along the long side of the light entrance surface 20a between the LED light sources 28 and the light guide plate 20. Accordingly, light dispersed from the LED light sources 28 out of the light guide plate 20 is directed to the light guide plate 20 by the reflection members 34a and 34b. This improves the efficiency in directing light emitted from the LED light source 28 to the light guide plate 20.

In the present embodiment, the resist 35 is provided on the front surface of the LED board 30 and configured to emit light. Accordingly, light dispersed from the LED light sources 28 on the front surface of the LED board 30 is directed to the light guide plate 20 by the resist 35. This improves the efficiency in directing light emitted from the LED light sources 28 to the light guide plate 20.

### Second Embodiment

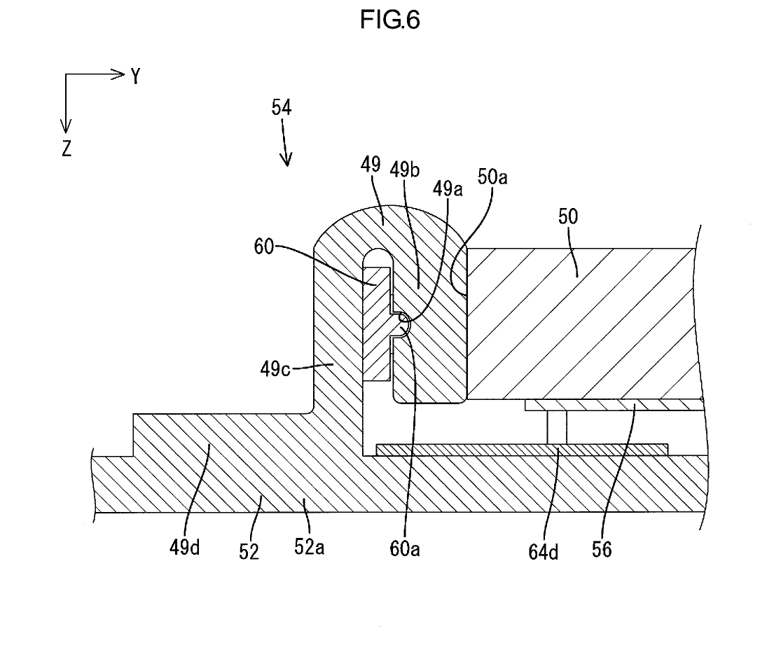

FIG. 6 is a magnified sectional view illustrating a part of the backlight unit 54 according to the second embodiment. FIG. 6 illustrates a sectional configuration of the vicinity of one of the board holding members 49 in the backlight unit 54 taken along the YZ plane so as to pass through the board holding member 49. The second embodiment is different from the first embodiment in the arrangement of a recess 49a and a protrusion 60a, the method of connecting an LED board 60 to the external terminals and the method of forming the board holding member 49. The members in FIG. 6 denoted by reference numerals that thirty is added to the reference numerals in FIG. 4 are the same members explained in the first embodiment. The construction, operations and effects as same as the first embodiment will not be explained.

As illustrated in FIG. 6, the board holding member 49 includes the recess 49a in the backlight unit 54 of the second embodiment. The recess 49a is formed in the front surface of the restriction portion 49b that faces the LED board 60. The protrusion 60a is provided on a front surface of the LED board 60 that faces the recess 49a of the board holding member 49. The protrusion 60a is formed in a hemispherical shape so as to project toward the recess 49a. The recess 49a of the board holding member 49 has a size such that the protrusion 60a is fitted therein. The protrusion 60a of the LED board 60 is fitted in the recess 49a of the board holding member 49, and accordingly, the board holding member 49 holds the LED board 60 and fixes the position thereof.

The board holding member 49 is apart of a backlight chassis 52 and extends from a bottom plate 52a thereof in the second embodiment. Accordingly, the backlight chassis 52 and the board holding member 49 can be integrally formed.

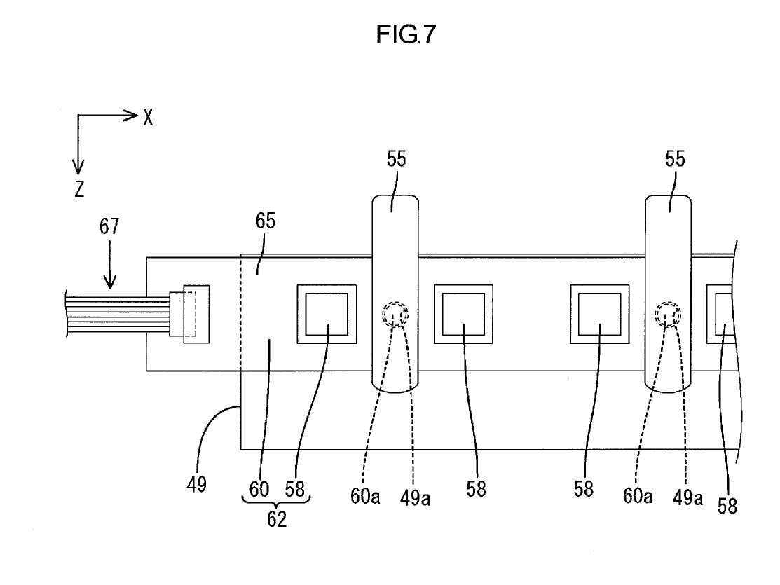

FIG. 7 illustrates a front view of a part of the board holding member 49 and a part of the LED unit 62. As illustrated in FIG. 7, a flexible board 67 is connected with a horizontal end of the LED board 60. The LED board 60 is electrically connected to the power supply circuit board via the flexible board 67. A connecting portion between the LED board 60 and the power supply circuit board has flexibility, and therefore, a contact failure and a malfunction are less likely to occur.

### Third Embodiment

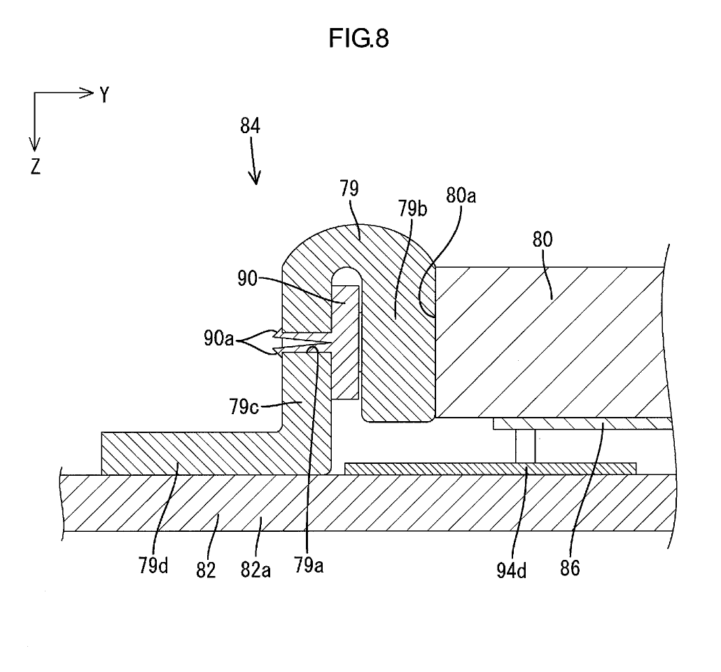

FIG. 8 is a magnified sectional view illustrating a part of the backlight unit 84 according to the third embodiment. FIG. 8 illustrates a sectional configuration of the vicinity of one of board holding members 79 in the backlight unit 84 taken along the YZ plane so as to pass through the board holding member 79. The third embodiment is different from the first embodiment in the arrangement and construction of a protrusion 90a and in forming a through hole 79a instead of the recess. The members in FIG. 8 denoted by reference numerals that sixty is added to the reference numerals in FIG. 4 are the same members explained in the first embodiment. The construction, operations and effects as same as the first embodiment will not be explained.

As illustrated in FIG. 8, the protrusion 90a is provided on the front surface of the LED board 90 that faces the side plate portion 79c of the board holding member 79 in the backlight unit 84 of the third embodiment. The through hole 79a is formed in a side plate portion 79c of the board holding member 79 that faces the protrusion 90a of the LED board 90. The protrusion 90a is formed in a rivet shape so as to protrude through the through hole 79a. The through hole 79a has a size such that the protrusion 90a is fitted in the through hole 79a. The protrusion 90a of the LED board 90 is fitted in the through hole 79a of the board holding member 79. With such a configuration, the board holding member 79 holds the LED board 90 and fixes the position thereof. The protrusion 90a is passed through the through hole 79a and held to an opposite surface of the side plate portion 79c. Accordingly, the board holding member 79 holds the LED board 90 in the vertical direction (Y-axis direction). In the backlight unit 84 of the third embodiment, the protrusion 90a is formed in a rivet shape so as to protrude. With this configuration, the LED board 90 can be properly fixed to the board holding member 79.

Correspondence relationships between the construction of the embodiments and the construction of the present invention will be described. The LED boards 30, 60, and 90 are an example of a “light source board.” The LED light sources 28, 58 and 88 are an example of a “light source.” The backlight chassis 22, 52 and 82 are an example of a “housing member.” The backlight units 24, 54 and 84 are an example of a “lighting device.” The reflection members 34a, 34b, 64b and 94b are an example of a “first reflection member.” The resists 35 and 65 are an example of a “second reflection member.” The liquid crystal devices 10, 40 and 70 are an example of a “display device.”

(1) In the above embodiments, the LED light sources are provided so as to face the two side surfaces that are provided on opposite sides of the light guide plate. However, the LED light sources may be provided so as to face a single side surface of the light guide plate, three side surfaces thereof or all (four) side surfaces of the light guide plate.

(2) In the above embodiments, the restriction portion of the board holding member is in contact with the light guide plate. However, the thickness of the restriction portion may only to be greater than the thickness of the LED light source. The restriction portion may not be in contact with the light guide plate.

(3) The arrangement and configuration of the recess and the protrusion may be altered if necessary.

(4) The configuration of the board holding member may be altered if necessary.

(5) In the above embodiments, the liquid crystal display device including the liquid crystal panel as a display panel is described. The technology can be applied to display devices including other types of display components.

(6) In the above embodiments, the television receiver including the tuner is used. However, the technology can be applied to a display device without a tuner.

The embodiments according to the present invention have been described in detail. The embodiments are for illustrative purposes only and by no means limit the scope of the present invention. Technologies described in the present invention include variations and modifications of the embodiments and examples described above.

The technical elements described or shown in the specification or drawings exhibit the technical usefulness individually or in various combinations thereof. The technical elements are not limited to the combinations defined in the claims at the time of filing the application. Furthermore, the technologies illustrated in the specification or drawings realize a plurality of purposes at the same time and have a technical usefulness when one of the purposes is realized.

### Explanation of Symbols

TV: television receiver, Ca, Cb: cabinet, T: tuner, S: stand, 10: liquid crystal display device, 12a: top bezel, 12b: bottom bezel, 12c: side bezel, 13: insulating layer, 14a: top frame, 14b: bottom frame, 14c side frame, 15: driving circuit board, 16: liquid crystal panel, 18: optical member, 18a: diffuser sheet, 18b: lens sheet, 18c: reflecting type polarizing sheet, 19, 49, 79: board holding member, 19a, 60a, 90a: protrusion, 19b, 49b, 79b: restriction portion, 19c, 49c, 79c: side plate portion, 19d, 49d, 79d: bottom plate portion, 20, 50, 80: light guide plate, 20a, 50a, 80a: light entrance surface, 20b: light exit surface, 20c: surface opposite to light exit surface, 22, 52, 82: backlight chassis, 22a: bottom plate, 22z: bottom surface, 23: protection cover, 24, 54, 84: backlight unit, 26, 56, 86: light reflection sheet, 28, 58, 88: LED light source, 30, 60, 90: LED board, 30a, 49a: recess, 31: cable holder, 32, 62: LED unit, 33: rubber bushing, 34a, 34b, 64b, 94b: first reflection member, 35, 65: second reflection member, 37: connector terminal, 67: the flexible board, 79a: through hole

1. A lighting device comprising:
a light source board;
at least one light source provided on a surface of the light source board;
a light guide plate including a light entrance surface on a side and configured to guide light from the at least one light source;
a housing member housing at least the light source board and the light guide plate;
a board holding member fixed to the housing member, the light source board is attached to the housing member such that the board holding member holds the light source board, and the board holding member including a restriction portion provided between the light guide plate and the light source board, the restriction portion having a thickness greater than that of the at least one light source such that a distance between the light guide plate and the light source board is maintained because of the thickness;
a protrusion provided on one of the light source board and the board holding member; and
a recess provided in another one of the light source board and the board holding member, wherein:
the another one of the light source board and the board holding member has a through hole; and
the protrusion is fitted in one of the recess and the through hole such that the light source board is held by the board holding member.

2. The lighting device according to claim 1, wherein the protrusion is formed in a rivet shape.

3. The lighting device according to claim 1, wherein the board holding member has higher heat conductivity than the light source board.

4. The lighting device according to claim 1, wherein the board holding member is a part of the housing member.

5. The lighting device according to claim 1, wherein:
the at least one light source includes a plurality of light sources arranged linearly on the surface of the light source board; and
the protrusion is fitted in one of the recess and the through hole between the adjacent light sources.

6. The lighting device according to claim 1, wherein the light source board is electrically connected to an external terminal through a connector terminal or a flexible board.

7. The lighting device according to claim 1, further comprising a first reflection member, wherein:
the light entrance surface is formed in an elongated shape; and
the first reflection member extends along a long side of the light entrance surface between the at least one light source and the light guide plate.

8. The lighting device according to claim 1, further comprising a second reflection member provided on the surface of the light source board.

9. A display device comprising:
the lighting device according to claims 1; and
a display panel configured to provide display using light from the lighting device.

10. The display device according to claim 9, wherein the display panel is a liquid crystal panel using liquid crystals.

11. A television receiver comprising the display device according to claim 9.
